(19) United States
(12) Patent Application Publication
(10) Pub. No.: US 2025/0148304 A1
(43) Pub. Date: May 8, 2025

(54) METHODS AND SYSTEMS FOR ENHANCING FUNCTIONALITY OF PREDICTIVE MODELS IN CONTACT CENTERS

(71) Applicant: GENESYS CLOUD SERVICES, INC., Menlo Park, CA (US)

(72) Inventors: JULIAN LEONARD, GALWAY (IE); GREG TOTH, GALWAY (IE); PETER ROCHE, GALWAY (IE); ORLA COLEMAN, GALWAY (IE); RAHUL CHHABRA, GALWAY (IE); FERGAL PAUL MONAGHAN, GALWAY (IE)

(73) Assignee: GENESYS CLOUD SERVICES, INC., Menlo Park, CA (US)

(21) Appl. No.: 18/386,324

(22) Filed: Nov. 2, 2023

(51) Int. Cl. G06N 5/022; G06N 7/01

(52) U.S. Cl. CPC G06N 5/022; G06N 7/01

(57) ABSTRACT

A method for classifying customers via operation of a probability score of a predictive model that expresses a probability of a customer achieving a predicted outcome. The method includes: recording previous probability scores and grouping within a dataset; sorting the dataset by an increasing value; deriving a set of reference quantiles based on the sorted previous probability scores of the dataset; determining action thresholds defining a range of target quantiles within the set of reference quantiles; receiving a probability score from the predictive model for a first customer in a current interaction; comparing the probability score of the first customer to the probability scores in the set of reference quantiles to determine a matching quantile; and determining if the matching quantile is within the range of target quantiles and, based thereon, selectively classifying the first customer in the target audience.

### BACKGROUND

The present invention generally relates to the use of predictive models and related analytics in the field of customer service and customer relations management via contact centers and associated cloud-based systems. More particularly, but not by way of limitation, the present invention pertains to automated systems and methods related to action thresholds of predictive models used in contact centers for improved functionality and enhanced usability.

### BRIEF DESCRIPTION OF THE INVENTION

The present invention describes a computer-implemented method for use in a contact center for classifying customers as being a member of target audience via operation of a predictive model. The predictive model being configured to output a probability score for each of the customers that expresses a probability that the customer will achieve a predicted outcome. The method may include the steps of: recording previous probability scores, wherein the previous probability scores include probability scores output by the predictive model in relation to previous interactions conducted by the contact center with respective previous customers, grouping the recorded previous probability scores within a dataset; sorting the previous probability scores of the dataset in order of an increasing value; deriving a set of reference quantiles based on the sorted previous probability scores contained in the dataset, wherein the deriving the set of the reference quantiles includes dividing the sorted previous probability scores into a number of equal sized quantiles; determining one or more action thresholds, the one or more action thresholds defining a range of target quantiles within the set of reference quantiles; receiving an output of a probability score from the predictive model for a first customer that is interacting with the contact center during a current interaction; comparing the probability score of the first customer to the probability scores contained within the quantiles of the set of reference quantiles to determine a matching quantile therewithin for the probability score of the first customer; and determining if the matching quantile is within the range of target quantiles and, based thereon, selectively classifying the first customer as being a member of the target audience.

These and other features of the present application will become more apparent upon review of the following detailed description of the example embodiments when taken in conjunction with the drawings and the appended claims.

### BRIEF DESCRIPTION OF THE DRAWINGS

A more complete appreciation of the present invention will become more readily apparent as the invention becomes better understood by reference to the following detailed description when considered in conjunction with the accompanying drawings, in which like reference symbols indicate like components, wherein:

FIG. 1 depicts a schematic block diagram of a computing device in accordance with exemplary embodiments of the present invention and/or with which exemplary embodiments of the present invention may be enabled or practiced;

FIG. 2 depicts a schematic block diagram of a communications infrastructure or contact center in accordance with exemplary embodiments of the present invention and/or with which exemplary embodiments of the present invention may be enabled or practiced;

FIG. 3 is a conventional user interface for defining a target audience for a predictive model of a contact center;

FIG. 4 is an exemplary user interface for defining a target audience for a predictive model of a contact center in accordance with embodiments of the present invention; and

FIG. 5 is an exemplary method for defining a target audience for a predictive model in accordance with embodiments of the present disclosure.

### DETAILED DESCRIPTION

For the purposes of promoting an understanding of the principles of the invention, reference will now be made to the exemplary embodiments illustrated in the drawings and specific language will be used to describe the same. It will be apparent, however, to one having ordinary skill in the art that the detailed material provided in the examples may not be needed to practice the present invention. In other instances, well-known materials or methods have not been described in detail in order to avoid obscuring the present invention. Additionally, further modification in the provided examples or application of the principles of the invention, as presented herein, are contemplated as would normally occur to those skilled in the art.

As used herein, language designating nonlimiting examples and illustrations includes “e.g.”, “i.e.”, “for example”, “for instance” and the like. Further, reference throughout this specification to “an embodiment”, “one embodiment”, “present embodiments”, “exemplary embodiments”, “certain embodiments” and the like means that a particular feature, structure or characteristic described in connection with the given example may be included in at least one embodiment of the present invention. Thus, appearances of the phrases “an embodiment”, “one embodiment”, “present embodiments”, “exemplary embodiments”, “certain embodiments” and the like are not necessarily referring to the same embodiment or example. Further, particular features, structures or characteristics may be combined in any suitable combinations and/or sub-combinations in one or more embodiments or examples.

Those skilled in the art will recognize from the present disclosure that the various embodiments may be computer implemented using many different types of data processing equipment, with embodiments being implemented as an apparatus, method, or computer program product. Example embodiments, thus, may take the form of an entirely hardware embodiment, an entirely software embodiment, or an embodiment combining software and hardware aspects. Example embodiments further may take the form of a computer program product embodied by computer-usable program code in any tangible medium of expression. In each case, the example embodiment may be generally referred to as a “module”, “system”, or “method”.

### Computing Device

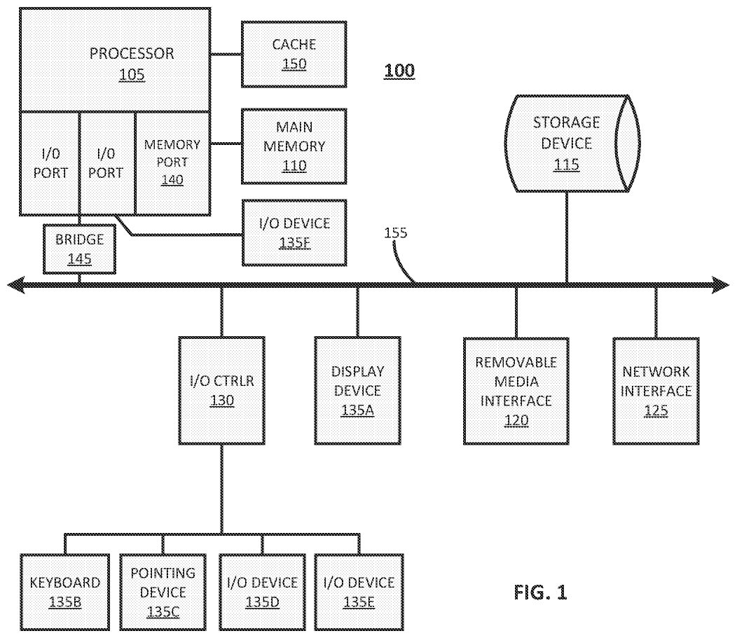

It will be appreciated that the systems and methods of the present invention may be computer implemented using many different forms of data processing equipment, for example, digital microprocessors and associated memory, executing appropriate software programs. By way of background, FIG. 1 illustrates a schematic block diagram of an exemplary computing device 100 in accordance with embodiments of the present invention and/or with which those embodiments may be enabled or practiced. FIG. 1 is provided as a non-limiting example.

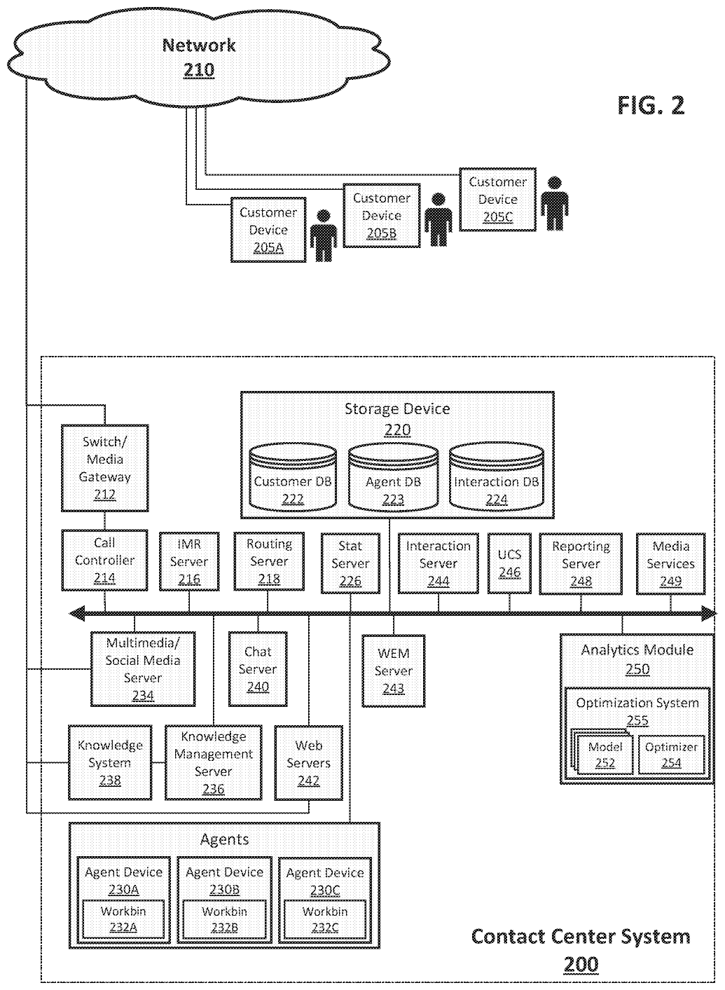

The computing device 100, for example, may be implemented via firmware (e.g., an application-specific integrated circuit), hardware, or a combination of software, firmware, and hardware. It will be appreciated that each of the servers, controllers, switches, gateways, engines, and/or modules in the following figures (which collectively may be referred to as servers or modules) may be implemented via one or more of the computing devices 100. As an example, the various servers may be a process running on one or more processors of one or more computing devices 100, which may be executing computer program instructions and interacting with other systems or modules in order to perform the various functionalities described herein. Unless otherwise specifically limited, the functionality described in relation to a plurality of computing devices may be integrated into a single computing device, or the various functionalities described in relation to a single computing device may be distributed across several computing devices. Further, in relation to the computing systems described in the following figures—such as, for example, the contact center system 200 of FIG. 2—the various servers and computer devices thereof may be located on local computing devices 100 (i.e., on-site or at the same physical location as contact center agents), remote computing devices 100 (i.e., off-site or in a cloud computing environment, for example, in a remote data center connected to the contact center via a network), or some combination thereof. Functionality provided by servers located on off-site computing devices may be accessed and provided over a virtual private network (VPN), as if such servers were on-site, or the functionality may be provided using a software as a service (SaaS) accessed over the Internet using various protocols, such as by exchanging data via extensible markup language (XML), JSON, and the like.

As shown in the illustrated example, the computing device 100 may include a central processing unit (CPU) or processor 105 and a main memory 110. The computing device 100 may also include a storage device 115, removable media interface 120, network interface 125, I/O controller 130, and one or more input/output (I/O) devices 135, which as depicted may include an, display device 135A, keyboard 135B, and pointing device 135C. The computing device 100 further may include additional elements, such as a memory port 140, a bridge 145, I/O ports, one or more additional input/output devices 135D, 135E, 135F, and a cache memory 150 in communication with the processor 105.

The processor 105 may be any logic circuitry that responds to and processes instructions fetched from the main memory 110. For example, the process 105 may be implemented by an integrated circuit, e.g., a microprocessor, microcontroller, or graphics processing unit, or in a field-programmable gate array or application-specific integrated circuit. As depicted, the processor 105 may communicate directly with the cache memory 150 via a secondary bus or backside bus. The cache memory 150 typically has a faster response time than main memory 110. The main memory 110 may be one or more memory chips capable of storing data and allowing stored data to be directly accessed by the central processing unit 105. The storage device 115 may provide storage for an operating system, which controls scheduling tasks and access to system resources, and other software. Unless otherwise limited, the computing device 100 may include an operating system and software capable of performing the functionality described herein.

As depicted in the illustrated example, the computing device 100 may include a wide variety of I/O devices 135, one or more of which may be connected via the I/O controller 130. Input devices, for example, may include a keyboard 135B and a pointing device 135C, e.g., a mouse or optical pen. Output devices, for example, may include video display devices, speakers, and printers. The I/O devices 135 and/or the I/O controller 130 may include suitable hardware and/or software for enabling the use of multiple display devices. The computing device 100 may also support one or more removable media interfaces 120, such as a disk drive, USB port, or any other device suitable for reading data from or writing data to computer readable media. More generally, the I/O devices 135 may include any conventional devices for performing the functionality described herein.

The computing device 100 may be any workstation, desktop computer, laptop or notebook computer, server machine, virtualized machine, mobile or smart phone, portable telecommunication device, media playing device, gaming system, mobile computing device, or any other type of computing, telecommunications or media device, without limitation, capable of performing the operations and functionality described herein. The computing device 100 include a plurality of devices connected by a network or connected to other systems and resources via a network. As used herein, a network includes one or more computing devices, machines, clients, client nodes, client machines, client computers, client devices, endpoints, or endpoint nodes in communication with one or more other computing devices, machines, clients, client nodes, client machines, client computers, client devices, endpoints, or endpoint nodes. It should be understood that, unless otherwise limited, the computing device 100 may communicate with other computing devices 100 via any type of network using any conventional communication protocol. Further, the network may be a virtual network environment where various network components are virtualized.

### Contact Center

With reference now to FIG. 2, a communications infrastructure or contact center system 200 is shown in accordance with exemplary embodiments of the present invention and/or with which exemplary embodiments of the present invention may be enabled or practiced. It should be understood that the term “contact center system” is used herein to refer to the system depicted in FIG. 2 and/or the components thereof, while the term “contact center” is used more generally to refer to contact center systems, customer service providers operating those systems, and/or the organizations or enterprises associated therewith. Thus, unless otherwise specifically limited, the term “contact center” refers generally to a contact center system (such as the contact center system 200), the associated customer service provider (such as a particular customer service provider providing customer services through the contact center system 200), as well as the organization or enterprise on behalf of which those customer services are being provided.

By way of background, customer service providers generally offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals” or “customers”). For example, the agents at a contact center may assist customers in making purchasing decisions, receiving orders, or solving problems with products or services already received. Within a contact center, such interactions between contact center agents and outside entities or customers may be conducted over a variety of communication channels, such as, for example, via voice (e.g., telephone calls or voice over IP or VoIP calls), video (e.g., video conferencing), text (e.g., emails and text chat), screen sharing, co-browsing, or the like.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize automated processes in place of live agents, such as, for example, interactive voice response (IVR) systems, interactive media response (IMR) systems, internet robots or “bots”, automated chat modules or “chatbots”, and the like.

Referring specifically to FIG. 2, the contact center system 200 may be used by a customer service provider to provide various types of services to customers. For example, the contact center system 200 may be used to engage and manage interactions in which automated processes (or bots) or human agents communicate with customers. As should be understood, the contact center system 200 may be an in-house facility to a business or enterprise for performing the functions of sales and customer service relative to products and services available through the enterprise. In another aspect, the contact center system 200 may be operated by a third-party service provider that contracts to provide services for another organization. Further, the contact center system 200 may be deployed on equipment dedicated to the enterprise or third-party service provider, and/or deployed in a remote computing environment such as, for example, a private or public cloud environment with infrastructure for supporting multiple contact centers for multiple enterprises. The contact center system 200 may include software applications or programs, which may be executed on premises or remotely or some combination thereof. It should further be appreciated that the various components of the contact center system 200 may be distributed across various geographic locations and not necessarily contained in a single location or computing environment.

Unless otherwise specifically limited, any of the computing elements of the present invention may be implemented in cloud-based or cloud computing environments. As used herein, “cloud computing”—or, simply, the “cloud”—is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Often referred to as a “serverless architecture”, a cloud execution model generally includes a service provider dynamically managing an allocation and provisioning of remote servers for achieving a desired functionality.

In accordance with the illustrated example of FIG. 2, the components or modules of the contact center system 200 may include: a plurality of customer devices 205A, 205B, 205C; communications network (or simply “network”) 210; switch/media gateway 212; call controller 214; interactive media response (IMR) server 216; routing server 218; storage device 220; statistics (or “stat”) server 226; plurality of agent devices 230A, 230B, 230C that include workbins 232A, 232B, 232C, respectively; multimedia/social media server 234; knowledge management server 236 coupled to a knowledge system 238; chat server 240; web servers 242; interaction (or “iXn”) server 244; universal contact server (or “UCS”) 246; reporting server 248; media services server 249; and analytics module 250. It should be understood that any of the computer-implemented components, modules, or servers described in relation to FIG. 2 or in any of the following figures may be implemented via types of computing devices, such as, for example, the computing device 100 of FIG. 1. As will be seen, the contact center system 200 generally manages resources (e.g., personnel, computers, telecommunication equipment, etc.) to enable delivery of services via telephone, email, chat, or other communication mechanisms. Such services may vary depending on the type of contact center and, for example, may include customer service, help desk functionality, emergency response, telemarketing, order taking, and the like.

Customers desiring to receive services from the contact center system 200 may initiate inbound communications (e.g., telephone calls, emails, chats, etc.) to the contact center system 200 via a customer device 205. While FIG. 2 shows three such customer devices—i.e., customer devices 205A, 205B, and 205C—it should be understood that any number may be present. The customer devices 205, for example, may be a communication device, such as a telephone, smart phone, computer, tablet, or laptop. In accordance with functionality described herein, customers may generally use the customer devices 205 to initiate, manage, and conduct communications with the contact center system 200, such as telephone calls, emails, chats, text messages, web-browsing sessions, and other multi-media transactions.

Inbound and outbound communications from and to the customer devices 205 may traverse the network 210, with the nature of network typically depending on the type of customer device being used and form of communication. As an example, the network 210 may include a communication network of telephone, cellular, and/or data services. The network 210 may be a private or public switched telephone network (PSTN), local area network (LAN), private wide area network (WAN), and/or public WAN such as the Internet. Further, the network 210 may include a wireless carrier network including a code division multiple access (CDMA) network, global system for mobile communications (GSM) network, or any wireless network/technology conventional in the art, including but not limited to 3G, 4G, LTE, 5G, etc.

In regard to the switch/media gateway 212, it may be coupled to the network 210 for receiving and transmitting telephone calls between customers and the contact center system 200. The switch/media gateway 212 may include a telephone or communication switch configured to function as a central switch for agent level routing within the center. The switch may be a hardware switching system or implemented via software. For example, the switch 215 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 230. Thus, in general, the switch/media gateway 212 establishes a voice connection between the customer and the agent by establishing a connection between the customer device 205 and agent device 230.

As further shown, the switch/media gateway 212 may be coupled to the call controller 214 which, for example, serves as an adapter or interface between the switch and the other routing, monitoring, and communication-handling components of the contact center system 200. The call controller 214 may be configured to process PSTN calls, VoIP calls, etc. For example, the call controller 214 may include computer-telephone integration (CTI) software for interfacing with the switch/media gateway and other components. The call controller 214 may include a session initiation protocol (SIP) server for processing SIP calls. The call controller 214 may also extract data about an incoming interaction, such as the customer's telephone number, IP address, or email address, and then communicate these with other contact center components in processing the interaction.

In regard to the interactive media response (IMR) server 216, it may be configured to enable self-help or virtual assistant functionality. Specifically, the IMR server 216 may be similar to an interactive voice response (IVR) server, except that the IMR server 216 is not restricted to voice and may also cover a variety of media channels. In an example illustrating voice, the IMR server 216 may be configured with an IMR script for querying customers on their needs. For example, a contact center for a bank may tell customers via the IMR script to “press 1” if they wish to retrieve their account balance. Through continued interaction with the IMR server 216, customers may receive service without needing to speak with an agent. The IMR server 216 may also be configured to ascertain why a customer is contacting the contact center so that the communication may be routed to the appropriate resource.

In regard to the routing server 218, it may function to route incoming interactions. For example, once it is determined that an inbound communication should be handled by a human agent, functionality within the routing server 218 may select the most appropriate agent and route the communication thereto. This type of functionality may be referred to as predictive routing. Such agent selection may be based on which available agent is best suited for handling the communication. More specifically, the selection of appropriate agent may be based on a routing strategy or algorithm that is implemented by the routing server 218. In doing this, the routing server 218 may query data that is relevant to the incoming interaction, for example, data relating to the particular customer, available agents, and the type of interaction, which, as described more below, may be stored in particular databases. Once the agent is selected, the routing server 218 may interact with the call controller 214 to route (i.e., connect) the incoming interaction to the corresponding agent device 230. As part of this connection, information about the customer may be provided to the selected agent via their agent device 230. This information is intended to enhance the service the agent is able to provide to the customer.

Regarding data storage, the contact center system 200 may include one or more mass storage devices—represented generally by the storage device 220—for storing data in one or more databases relevant to the functioning of the contact center. For example, the storage device 220 may store customer data that is maintained in a customer database 222. Such customer data may include customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 220 may store agent data in an agent database 223. Agent data maintained by the contact center system 200 may include agent availability and agent profiles, schedules, skills, handle time, etc. As another example, the storage device 220 may store interaction data in an interaction database 224. Interaction data may include data relating to numerous past interactions between customers and contact centers. More generally, it should be understood that, unless otherwise specified, the storage device 220 may be configured to include databases and/or store data related to any of the types of information described herein, with those databases and/or data being accessible to the other modules or servers of the contact center system 200 in ways that facilitate the functionality described herein. For example, the servers or modules of the contact center system 200 may query such databases to retrieve data stored therewithin or transmit data thereto for storage.

In regard to the stat server 226, it may be configured to record and aggregate data relating to the performance and operational aspects of the contact center system 200. Such information may be compiled by the stat server 226 and made available to other servers and modules, such as the reporting server 248, which then may use the data to produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 230 of the contact center 200 may be communication devices configured to interact with the various components and modules of the contact center system 200 in ways that facilitate functionality described herein. An agent device 230, for example, may include a telephone adapted for regular telephone calls or VoIP calls. An agent device 230 may further include a computing device configured to communicate with the servers of the contact center system 200, perform data processing associated with operations, and interface with customers via voice, chat, email, and other multimedia communication mechanisms according to functionality described herein. While FIG. 2 shows three such agent devices—i.e., agent devices 230A, 230B and 230C—it should be understood that any number may be present.

In regard to the multimedia/social media server 234, it may be configured to facilitate media interactions (other than voice) with the customer devices 205 and/or the servers 242. Such media interactions may be related, for example, to email, voice mail, chat, video, text-messaging, web, social media, co-browsing, etc. The multi-media/social media server 234 may take the form of any IP router conventional in the art with specialized hardware and software for receiving, processing, and forwarding multi-media events and communications.

In regard to the knowledge management server 234, it may be configured facilitate interactions between customers and the knowledge system 238. In general, the knowledge system 238 may be a computer system capable of receiving questions or queries and providing answers in response. The knowledge system 238 may be included as part of the contact center system 200 or operated remotely by a third party. The knowledge system 238 may include an artificially intelligent computer system capable of answering questions posed in natural language by retrieving information from information sources such as encyclopedias, dictionaries, newswire articles, literary works, or other documents submitted to the knowledge system 238 as reference materials, as is known in the art. As an example, the knowledge system 238 may be embodied as IBM Watson or a like system.

In regard to the chat server 240, it may be configured to conduct, orchestrate, and manage electronic chat communications with customers. In general, the chat server 240 is configured to implement and maintain chat conversations and generate chat transcripts. Such chat communications may be conducted by the chat server 240 in such a way that a customer communicates with automated chatbots, human agents, or both. In exemplary embodiments, the chat server 240 may perform as a chat orchestration server that dispatches chat conversations among the chatbots and available human agents. In such cases, the processing logic of the chat server 240 may be rules driven so to leverage an intelligent workload distribution among available chat resources. The chat server 240 further may implement, manage and facilitate user interfaces (also UIs) associated with the chat feature, including those UIs generated at either the customer device 205 or the agent device 230. The chat server 240 may be configured to transfer chats within a single chat session with a particular customer between automated and human sources such that, for example, a chat session transfers from a chatbot to a human agent or from a human agent to a chatbot. The chat server 240 may also be coupled to the knowledge management server 234 and the knowledge systems 238 for receiving suggestions and answers to queries posed by customers during a chat so that, for example, links to relevant articles can be provided.

In regard to the web servers 242, such servers may be included to provide site hosts for a variety of social interaction sites to which customers subscribe, such as Facebook, Twitter, Instagram, etc. Though depicted as part of the contact center system 200, it should be understood that the web servers 242 may be provided by third parties and/or maintained remotely. The web servers 242 may also provide webpages for the enterprise or organization being supported by the contact center system 200. For example, customers may browse the webpages and receive information about the products and services of a particular enterprise. Within such enterprise webpages, mechanisms may be provided for initiating an interaction with the contact center system 200, for example, via web chat, voice, or email. An example of such a mechanism is a widget, which can be deployed on the webpages or websites hosted on the web servers 242. As used herein, a widget refers to a user interface component that performs a particular function. In some implementations, a widget may include a graphical user interface control that can be overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Some widgets can include corresponding or additional user interfaces and be configured to access a variety of local resources (e.g., a calendar or contact information on the customer device) or remote resources via network (e.g., instant messaging, electronic mail, or social networking updates).

In regard to the interaction (iXn) server 244, it may be configured to manage deferrable activities of the contact center and the routing thereof to human agents for completion. As used herein, deferrable activities include back-office work that can be performed off-line, e.g., responding to emails, attending training, and other activities that do not entail real-time communication with a customer.

In regard to the universal contact server (UCS) 246, it may be configured to retrieve information stored in the customer database 222 and/or transmit information thereto for storage therein. For example, the UCS 246 may be utilized as part of the chat feature to facilitate maintaining a history on how chats with a particular customer were handled, which then may be used as a reference for how future chats should be handled. More generally, the UCS 246 may be configured to facilitate maintaining a history of customer preferences, such as preferred media channels and best times to contact. To do this, the UCS 246 may be configured to identify data pertinent to the interaction history for each customer such as, for example, data related to comments from agents, customer communication history, and the like. Each of these data types then may be stored in the customer database 222 or on other modules and retrieved as functionality described herein requires.

In regard to the reporting server 248, it may be configured to generate reports from data compiled and aggregated by the statistics server 226 or other sources. Such reports may include near real-time reports or historical reports and concern the state of contact center resources and performance characteristics, such as, for example, average wait time, abandonment rate, agent occupancy. The reports may be generated automatically or in response to specific requests from a requestor (e.g., agent, administrator, contact center application, etc.). The reports then may be used toward managing the contact center operations in accordance with functionality described herein.

In regard to the media services server 249, it may be configured to provide audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), speech recognition, dual tone multi frequency (DTMF) recognition, faxes, audio and video transcoding, secure real-time transport protocol (SRTP), audio conferencing, video conferencing, coaching (e.g., support for a coach to listen in on an interaction between a customer and an agent and for the coach to provide comments to the agent without the customer hearing the comments), call analysis, keyword spotting, and the like.

In regard to the analytics module 250, it may be configured to provide systems and methods for performing analytics on data received from a plurality of different data sources as functionality described herein may require. In accordance with example embodiments, the analytics module 250 also may generate, update, train, and modify predictors or models 252 based on collected data, such as, for example, customer data, agent data, and interaction data. The models 252 may include behavior models of customers or agents. The behavior models may be used to predict behaviors of, for example, customers or agents, in a variety of situations, thereby allowing embodiments of the present invention to tailor interactions based on such predictions or to allocate resources in preparation for predicted characteristics of future interactions, thereby improving overall contact center performance and the customer experience. It will be appreciated that, while the analytics module 250 is depicted as being part of a contact center, such behavior models also may be implemented on customer systems (or, as also used herein, on the “customer-side” of the interaction) and used for the benefit of customers.

According to exemplary embodiments, the analytics module 250 may have access to the data stored in the storage device 220, including the customer database 222 and agent database 223. The analytics module 250 also may have access to the interaction database 224, which stores data related to interactions and interaction content (e.g., transcripts of the interactions and events detected therein), interaction metadata (e.g., customer identifier, agent identifier, medium of interaction, length of interaction, interaction start and end time, department, tagged categories), and the application setting (e.g., the interaction path through the contact center). Further, as discussed below, the analytic module 250 may be configured to retrieve data stored within the storage device 220 for use in developing and training algorithms and models 252, for example, by applying machine learning techniques.

One or more of the included models 252 may be configured to predict customer or agent behavior and/or aspects related to contact center operation and performance. Further, one or more of the models 252 may be used in natural language processing and, for example, include intent recognition and the like. The models 252 may be developed based upon 1) known first principle equations describing a system, 2) data, resulting in an empirical model, or 3) a combination of known first principle equations and data. In developing a model for use with present embodiments, because first principles equations are often not available or easily derived, it may be generally preferred to build an empirical model based upon collected and stored data. To properly capture the relationship between the manipulated/disturbance variables and the controlled variables of complex systems, it may be preferable that the models 252 are nonlinear. This is because nonlinear models can represent curved rather than straight-line relationships between manipulated/disturbance variables and controlled variables, which are common to complex systems such as those discussed herein. Given the foregoing requirements, a machine learning or neural network-based approach is presently a preferred embodiment for implementing the models 252. Neural networks, for example, may be developed based upon empirical data using advanced regression algorithms.

The analytics module 250 may further include an optimizer 254. As will be appreciated, an optimizer may be used to minimize a “cost function” subject to a set of constraints, where the cost function is a mathematical representation of desired objectives or system operation. Because the models 252 may be non-linear, the optimizer 254 may be a nonlinear programming optimizer. It is contemplated, however, that the present invention may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like. The models 252 may include time series forecasting models as described in more detail below.

According to exemplary embodiments, the models 252 and the optimizer 254 may together be used within an optimization system 255. For example, the analytics module 250 may utilize the optimization system 255 as part of an optimization process by which aspects of contact center performance and operation are optimized or, at least, enhanced. This, for example, may include aspects related to the customer experience, agent experience, interaction routing, natural language processing, intent recognition, or other functionality related to automated processes.

The various components, modules, and/or servers of FIG. 2 (as well as the other figures included herein) may each include one or more processors executing computer program instructions and interacting with other system components for performing the various functionalities described herein. Such computer program instructions may be stored in a memory implemented using a standard memory device, such as, for example, a random-access memory (RAM), or stored in other non-transitory computer readable media such as, for example, a CD-ROM, flash drive, etc. Although the functionality of each of the servers is described as being provided by the particular server, a person of skill in the art should recognize that the functionality of various servers may be combined or integrated into a single server, or the functionality of a particular server may be distributed across one or more other servers without departing from the scope of the present invention. Further, the terms “interaction” and “communication” are used interchangeably, and generally refer to any real-time and non-real-time interaction that uses any communication channel including, without limitation, telephone calls (PSTN or VoIP calls), emails, vmails, video, chat, screen-sharing, text messages, social media messages, WebRTC calls, etc. Access to and control of the components of the contact system 200 may be affected through user interfaces (UIs) which may be generated on the customer devices 205 and/or the agent devices 230. As already noted, the contact center system 200 may operate as a hybrid system in which some or all components are hosted remotely, such as in a cloud-based or cloud computing environment.

### Predictive Models

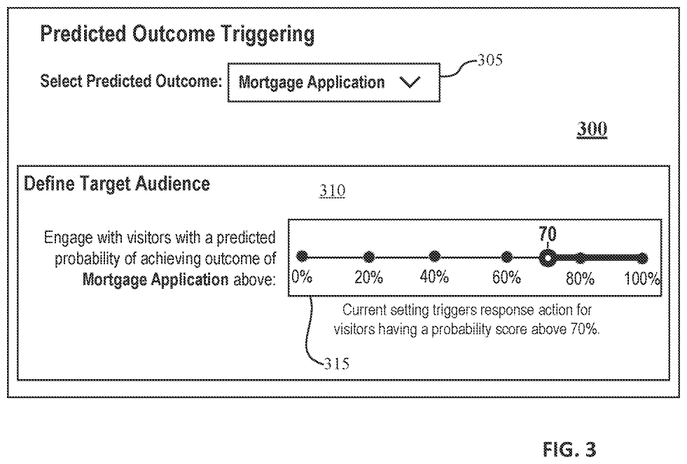

Turning now to FIGS. 3-5, the functionality and operation associated more particularly with the present invention will now be discussed in accordance with example embodiments. Before proceeding with this, though, background will be provided as to how contact centers use predictive models while also highlighting some example operational shortcomings that the present invention is intended to address.

Contact centers generally employ many types of predictive models to anticipate or predict customer behavior. Based on the predictions, contact centers can create proactive ways to better serve customers with automated services. Such models are usually predicated on artificial intelligence (AI) algorithms, such as machine learning or deep learning neural networks, and generally function by computing or outputting a probability score that expresses a likelihood that a prediction about a customer is correct. For example, a predictive model may compute a probability score expressing a likelihood with regard to an action that a customer may take or an interest a customer may have in a particular offer. Such probability scores may be used to calculate a likelihood that a customer would make a purchase if presented with a particular offer, or that a customer is about to end their visit to a website because of an inability to find what they are looking for, or that a customer is going to disconnect from a call with a contact center because the customer is having problems interaction with an automated agent.

When the probability score indicates a high likelihood of these kind of predictions coming true, a response action may be triggered by the contact center. As used herein, a response action is an automated action triggered by the contact center in response to the prediction, i.e., assuming that the prediction about the customer is correct. As will be appreciated, the response action is the response selected by the contact center as being desirable given the predicted situation. Predictive models typically operate in association with one or more action threshold defining when a response action is triggered. As used herein, an action threshold is a threshold probability for selectively initiating a response action. Specifically, the action threshold provides a demarcation between probability scores that result in the response action being triggered, which may also be referred to as positive use cases, and probability scores that do not result in the response action being triggered, which may also be referred to as negative use cases. In this way, the action threshold provides a recommendation as to whether a particular response action should be taken in a given situation. Thus, when an probability score of a predictive model fails to satisfy the probability defined by the applicable action threshold, it is interpreted as an instance when taking a particular action is not warranted. Alternatively, when an probability score satisfies the probability defined by the applicable action threshold, it is interpreted as an instance when taking the particular response action is warranted. Action maps may include one action threshold that divides a continuum into two segments that define positive and negative use cases. Further, more than one action threshold may be included within a continuum to define a particular target range.

An example of such predictive models is one used to recommend which customers should be offered a chat with a human agent based on behavior exhibited by the customers. The behavior upon which the prediction is based may include the manner in which the customer is interacting with the webpage of a business. For example, whether to offer the chat may be selectively based on a prediction that the customer is at least 70% likely to accept the chat or an offer associated with a particular product if the offer were presented via a chat. As another example, agent assistance for a customer interacting with an automated agent or bot may be triggered when the likelihood of customer needing such support is above 60%. Such action thresholds may be further based on a trained model and a desired performance level related to a particular operational KPI or metric of the contact center. Thus, chat support may be offered to customers who are 70% likely to accept because it is anticipated that such an action threshold would yield a given number of customers accepting chats, with that given number of customers being tied to a desirable level of service or other metric and achievable performance levels given current staffing. To continue the example, it is desirable that such probability thresholds be set at a level where the number of customers expected to accept the chat is commensurate to the number of agents available and their anticipated ability to handle that number of chats in accordance with a level of service defined in a service level agreement.

Another example of such predictive models analyzes the text derived from natural language conversations that occur between a contact center resource (such as a chatbot or agent) and a customer for predicting various outcomes related thereto. The conversations may occur over a text interface (i.e., chat) or via a voice interface (i.e., phone call or video conferencing). In the case of the latter, the voice data may be transcribed to text for analysis thereof. The predictive models may receive several different inputs such as the language being used, including semantic meaning, appearance of keywords, words reflecting negative sentiment, etc., as well as non-verbal data, such as tone, the amount of silence, amount over talk occurring, voice inflection, etc. This input data may be used to make several types of predictions as to different outcomes. For example, one prediction relates to the customer becoming frustrated and a need to escalate the interaction, which could include escalating the call from an automated service to a live agent or from a live agent to a supervisor. In such a case, the response action could be to automatically trigger the escalation. Another response action to a prediction that a customer is becoming frustrated in an ongoing interaction may include providing the agent with coaching, for example, with particular suggestions appearing on the agent's user device as to ways to soothe the customer or a special deal that could be offered to the customer. It will be appreciated that the present invention may be used in relation to any predictive model that is used to predict customer outcomes and response actions related thereto.

The AI algorithms used by such predictive models are generally designed to operate most effectively when the probability split between positive and negative is not heavily weighted toward one or the other, with an approximately 50/50 split being ideal. In practice, however, this type of scenario is rare. Generally the action being triggered by a positive use case represents the allocation of a limited resources. Such resources are often meant to be channeled toward relatively few cases that are rated as better prospects or higher value than most other cases. This results in negative use cases tending to greatly outweigh positive use cases. For example, a website may receive heavy traffic but only a small percentage of visitors are defined as consistent with a particular positive use case. The AI algorithms of the predictive models are able to handle this to an extent, but as lower and lower rates of the positive use case are encountered in the website's overall traffic—for example, when positive use cases are found in less than 5% of the cases—the predictive model begins to consider the positive use case as a rare event. This causes the algorithm of the predictive model to become more biased towards the negative use case, which results in the positive use case becoming an even rarer event. This reinforcing cycle results in predictions of the positive use case becoming exceedingly rare.

Of course, this is not the only issue that can occur with the outputs of predictive models. While the above example of bias toward negative use case predictions is encountered more often, the case could also arise where a predictive model skews in the oppositive direction. Additionally, the outputs of predictive models typically drift over time for a variety of reasons. Predictive models are also periodically updated or retrained on new datasets, which can introduce significant variability with the probability scores they output when the updated model is brought online. Each of these issues results in a need to modify probability action thresholds if consistent results are desired. As will be seen, the present invention provides a way to take into account the variability introduced by each of these problems so that the output of a predictive model continues to provide a consistent number of positive use cases. Further the positive use cases targeted at the right customers within a customer pool.

The primary obstacle to functionality with any of the above-described problems is that the predictive model produces outputs that are inconsistent with the expectations of an end user, and it becomes challenging for end users to properly employ the predictive model in a contact center setting. Such end users—which, for example, could include a contact center supervisor, operations manager or other similar personnel—increasingly find it difficult or impossible to consistently set action thresholds at appropriate probability levels for achieving a desired result. Continuing with the example of a predictive model that skews toward a low number of positive use cases, the low return of rate makes it difficult for end users to understand how the predictive model functions and, thus, how to employ the predictive features in a meaningful way. The model may return probability outputs that are much lower than the end user would expect to achieve when considering what would be appropriate to trigger a desired level of response actions. In the end, the optimal probability setting for the action thresholds make little sense to the end user, as it is far lower than would be anticipated. This is an ongoing issue for end users, particularly those who are attempting to self-manage settings toward efficient contact center operation.

Ultimately end users set action thresholds that seem reasonable or in accordance with their experience, but they are not achieving a desirable steady flow of positive use cases. As an example, an end user may reasonably expect that a threshold level of, say, above 60% probability would yield at least some customers triggering a positive use case. In practice, however, end users are often finding that such action thresholds yield few if any probabilities that satisfy the threshold, which, as explained above, is primarily due to the probability bias tending the predictions toward zero. One alternative is the use of a static percentage based action threshold. However, once set, such a threshold does not adjust to changes in the distribution of probabilities, which can result in unfavorable fluctuations in the audience. For example, changes in distribution can occur do to a variety of factors, such as UI changes to a website. The static nature of such thresholds means that end users are unable to guarantee a consistent flow of positive use cases, for example, customers to agent queues, which can impact agent utilization and revenue.

With reference to FIG. 3, an exemplary user interface 300 is shown that demonstrates a conventional interface by which end users can control the functioning of a predictive model. The user interface 300 may include two different user inputs for an end users. A first user input 305 provides a way for the end user to select between different predictive models. For example, when there are more than one predictive model that the end user controls, the first user input 305 allows the end user to select between those predictive models so to access the settings for each and make changes thereto. In the illustrated example, the predictive model that is presently selected is a “Mortgage Application” model, which, for example, may operate by providing a prediction as to how likely a customer (i.e., a visitor to a webpage) is to achieve the particular outcome of applying for a mortgage. Such a predictive model, for example, may base this type of prediction on behavior of the customer when interacting with the webpage, including the topics that the visitor searches, time spent on particular pages having certain topics, etc. To continue the example, the response action that is triggered for a positive use case may be an offer made to the customer for a live chat or voice interaction with an agent. As will be appreciated, the first user input 305 allows an end user to choose between different predictive models via reference to predictive outcomes, with the different predictive models accessible via a pulldown menu.

A second user input 310 allows the end user to define a target audience. Within the second user input 310, a slider 315 is provided that allows the end user to adjust an action threshold for triggering the action response. As explained within the text provided within the second user input 310, the setting of the slider 315 represents an action threshold that is tied to a predicted probability level. Thus, the action threshold is essentially a probability threshold with engagement of customers being dependent on the customer having a predicted probability of achieving the mortgage application outcome above the probability indicated by setting of the slider 315. In the illustrated example, with the slider set at 70% this means that the response action would be triggered for customers for which the output of the predictive model is a probability score above 70%. For many end users, this action thresholds would seem to be a reasonable one. However, as previously discussed, for many reasons—including, for example, the relatively low number of positive use cases for heavily trafficked websites and bias this causes within the AI models—such action thresholds yield few, or even no probabilities that satisfy the threshold. In fact, some predictive model outputs skew toward low probabilities that becomes impractical for an end user to even operate a slider input such as the one shown in FIG. 3, as it does not have the granularity that would be required.

Exemplary embodiments of the present invention offers an efficient way to resolve these ongoing problems. Specifically, it has been found that an effective solution involves mapping the problem of choosing probability thresholds to an alternative problem of choosing the quantity of the audience to target. In general, pursuant to exemplary embodiments, this approach may be achieved pursuant to a process that includes the following steps.

First, the probability scores calculated previously by the predictive model for customers are recorded and combined within a probability dataset. The probability scores included within this dataset may be those recorded during a prior operating period. The prior operating period may include a recent operating shift or several operating shifts occurring over consecutive days within a contact center. As more recent data is preferable, the prior operating period may be defined in relation to a current moment within a current operating period. For example, the prior operating period may be defined as a sliding lookback window that includes a predetermined number of previous operational units—such as minutes, hours, shifts, days, weeks, etc.—that occurred just prior to the current operating period or current moment therewithin. As will be appreciated, this results in the sliding lookback window including the most recent probability scores calculated by the predictive model, for example, those calculated over a predetermined number of the most recently completed shifts. Specifically, the sliding lookback window advances in time in relation to a current operating period or moment so that the most current outputs of the predictive model are gathered in this step. As described below, this results in the most current scores from the predictive model being used to derive the set of reference quantiles which are used to compare probability scores between customers. In this way, the most current operational results from the predictive model, including any bias or drift included therein, are accounted for when comparing results between customers. In an alternative embodiment, the same may be achieved by including within the probability dataset the most recent scores. Specifically, the probability scores gathered for inclusion in the probability dataset may include a predetermined number of the most recent scores made by the predictive model. In either case, the recorded probability scores are combined within the probability dataset for further analysis and use.

Second, the probability scores included within the probability dataset are sorted. In exemplary embodiments, the probability scores of the dataset are sorted in order of increasing probability. That is, the probability scores may be sorted from lowest probability score to highest probability. As will be appreciated, a predictive model may return several probability scores for the same type of prediction over the course of the same interaction with a given customer. For example, during a single web browsing session, the predictive model may return several probability scores for the customer as more behavior data is collected, e.g., as the customer interacts more with the website. In regard to sorting such probability scores within the probability dataset, the scores may be sorted according to a maximum probability score calculated by the predictive model for a given customer over the course of a particular interaction.

Third, the next step may include using the sorted probability dataset to derive the set of reference quantiles. In statistics and probability, a quantile is any of the groups produced by dividing a frequency distribution into equal groups, e.g., a quartile or percentile. Each quantile may contain the same fraction of the total population. Put another way, quantiles are cut points dividing the range of a probability distribution into continuous intervals with equal probabilities, or dividing the observations in a sample in the same way. As used herein, the set of reference quantiles refers to the set of quantiles derived from the sorted probability scores. As will be seen, the set of reference quantiles is then used to define one or more action thresholds that are used to classify current customers with regard to a target area defined by the one or more action threshold and, thereby, differentiate positive and negative use cases. The set of reference quantiles is calculated by dividing the sorted probability scores into equal sized groups or quantiles. For example, the sorted group of probability scores may be divided into 100 equal sized quantiles, which, as will be appreciated, are usually referred to as percentiles. In this case, it will be appreciated that the 1^{st} quantile of the set of reference quantiles contains 1% of the probability scores with the lowest probability, i.e., the 0-1% range of the customers yielding the lowest probability scores. The 2nd quantile of the set of reference quantiles would contain 1% of the probability scores, with that 1% including probability scores in the 1-2% range of scores, and so on. Thus, in the exemplary case of 100 quantiles, the population of probability scores contained in the probability dataset is divided into equal sized 1% groupings so that each grouping has the same number of probability scores. As will be appreciated, the set of reference quantiles maps the probability scores calculated by the predictive model—which, as described, are often skewed toward low probability levels—into equal sized audience quantiles. In this way, predictably sized groupings become discernible and ordered in accordance with those customers who are increasingly more likely to achieve the predicted outcome. As will be seen, the set of reference quantiles provides end users with a much more consistent and understandable method for identifying a target audience of an appropriate size as opposed to having to guess at an underlying probability threshold that achieves the same effect.

The number of quantiles included within the set of reference quantiles may be a predetermined or set number, such as 100 quantiles. Alternatively, the number of quantiles may be determined via a selection made by the end user that specifies the number of quantiles. As described, the present invention enables the identification of target customers by mapping a range of probabilities to a proportion of an audience, which is achieved by first dividing the total audience into an evenly-sized quantiles. In exemplary embodiments, the number of quantiles used within the set of reference quantiles can vary in accordance with a desired granularity, which can be specified by an end user. For example, the approach may be scaled up for greater granularity, which can be useful to an end user who needs to fine tune an action maps for a large population of customers. This may be done to a whatever level of granularity is necessary to permit a proper balance between positive use cases and available agents. As another example, the approach may use milliles instead of percentiles. As will be appreciated, with milliles, the total population contained in the dataset would be divided into 1,000 quantiles rather than the 100 quantiles of percentiles. As will be appreciated, this level of granularity may be appropriate for a large organization who needs to define a target group of customers with finer granularity. If still greater granularity is needed, the overall population of probability scores may be divided into a larger number of quantiles, such as 1,000,000 quantiles. Additionally, the approach can be scaled down is reduced granularity is desired. For example, a smaller number of quantiles may be used, such as deciles, which would include 10 quantiles (0-10%, 10-20%, etc.), quintiles, which would include 5 quantiles (0-20%, 20-40%, etc.), or even median, which would include 2 quantiles (0-50%, 50-100%).

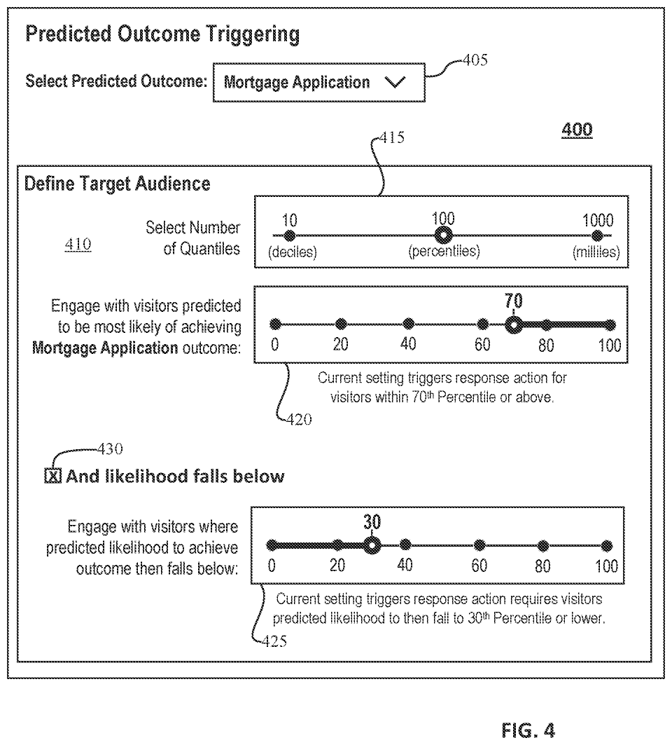

The above steps describe how the set of reference quantiles is derived. Focus will now turn to how the set of reference quantiles is used operationally to differentiate positive and negative use cases in relation to a customer that are currently interacting with the contact center. Toward this end, the set of reference quantiles provides a way to set action thresholds that focuses on how the probability score calculated for given customer compares to those calculated for other customers that are used to derive the set of reference quantiles. Such functionality may begin by receiving inputs from an end user specifying a preferred size of the set of reference quantiles and an action threshold in relation to it. These subjects will be discussed with reference to FIG. 4.

FIG. 4 depicts an exemplary user interface 400 in accordance with the present invention. As will be appreciated, there are similarities between the user interface 400 of FIG. 4 and the user interface 300 of FIG. 3. One of these similarities is the first user input 405 of FIG. 4. In the same way as described above in relation to the first user input 305 of the user interface 300, the first user input 405 of the user interface 400 allows an end user to select between different predictive models. Further, a second user input 410 is provided in the user interface 400 that allows the end user to define a target audience. The second user input 410 of the user interface 400 provides additional user selections and functionality that are not included in the example of FIG. 3. Also, as discussed in detail below, the manner in which a probability score of a customer is used to identify a target audience is modified in accordance with the present invention.

The second user input 410 of the user interface 400 of FIG. 4 is configured to receive several types of user inputs. The mechanisms for receiving these inputs may include a quantile selector 415, a first slider 420, and a second slider 425. As described above, the number of quantiles used to derive the set of reference quantiles can vary in accordance with a desired granularity. The quantile selector 415 provides a way for the user to select between alternative granularities. As shown, the number of optional quantiles provided in the example of FIG. 4 is 10 quantiles, 100 quantiles, or 1000 quantiles. Other number of quantiles could also be offered or the user could be allowed to specify a desired number. As depicted, the end user has selected the option of 100 quantiles (i.e., percentiles). The number of quantiles could also be preset to a fixed amount, such as 100 quantiles. In such cases, the user interface would be arranged so that the selection of quantiles is omitted.

In regard to the first slider 420, this feature allows the end user to define an action threshold in relation to a selected quantiles within the set of reference quantiles. In doing this, the end user defines a range of the target quantiles that define positive use cases was well as a remaining range of the quantiles that define negative use cases. As will be appreciated, this feature may include a way for the end user to define more than one action threshold, so that an imbedded range of target quantiles could be defined. In the illustrated case in which the set of reference quantiles has 100 quantiles, the end user defines an action threshold by moving the first slider 420 along the defined continuum until a desired one of the quantiles is selected. This selected quantile then becomes the threshold quantile by which the action threshold is defined. As depicted, the 70^{th} quantile has been selected. The 70^{th} quantile then becomes the dividing line or boundary that marks the point at which positive use cases begin. Thus, the range above the threshold quantile, which, to continue the illustrated example, is the range defined between the 70^{th} quantile and the 100^{th} quantile, becomes the range of target quantiles defining the positive use cases, while the range below the threshold quantile, which is the range defined between the 1^{st} quantile and the 69^{th} quantile, becomes the range defining the negative use cases.

The second slider 425 may be provided as an optional tool for adding further requirements as to how the target audience is defined. For example, the second slider 425 may be used in conjunction with the first slider 420 to define a positive use case in accordance with a likelihood that changes significantly for a particular customer. If an end user has activated the box 430 that operationally enables this feature, a positive use case is then identified as a combination of the first slider 420 and the second slider 425. This combination requires that a customer first meet the requirements of the first slider (70^{th} quantile or greater) and, thereafter, experience a change in likelihood so that the customer then meets the requirements of the second slider 425 (30^{th} quantile or lower). This way of defining the target audience is intended to identify customers that first exhibited a higher likelihood of achieving an outcome but then seemed to have a change of mind. The strategy behind targeting this type of audience is that the triggered response action—for example, being directed to a live interaction with an agent—is best utilized if it is steered toward customers that had a higher level of likelihood but then registered a significantly lower level. The idea here is that the initial higher interest level of such customers may be rekindled if resources, such as talking with an agent, are provided to these customers.

Now, assuming that a system of the present invention has been configured as described above—including the derivation of the set of reference quantiles and the defining of action thresholds—exemplary operation will be discussed with reference to an exemplary customer, who will be referred as a “Customer Carl” or simply “Carl”. In this discussion, it will be assumed that the settings of the exemplary user interface 400 of FIG. 4 are those that have been selected and are in operational use.

The process may begin with Customer Carl interacting in some way with the services offered by a contact center. In this example, Carl is interacting with a website of a business, with the contact center providing services to customers for the business. While interacting with the website, Carl exhibits behaviors that are recorded and provided as input to a predictive model that is configured to output a probability score that indicates a calculated probability that Carl will achieve a particular outcome. The predictive model receives the inputs and begins to make predictions as to the probability of the Carl achieving the outcome. The predictive model updates the prediction being made about Carl as more inputs regarding the behavior of the Carl are received.

At some point during Carl's interaction with the website, the predictive model makes a first prediction, which is that the probability of Carl achieving the desired outcome is 3%. Thus, the first prediction produces a probability score of 3%. In accordance with methods of the present invention, this probability score is used to determine if Carl satisfies the requirements of the first slider 420 (i.e., whether Carl is a member of the target audience). To do this, the set of reference quantiles is consulted to determine which of the included quantiles would apply to a probability score of 3% (i.e., in which quantile does the probability score of Carl best match the probability scores included therewithin). As used herein, this quantile will be referred to as a matching quantile. The matching quantile may be determined, for example, by finding the quantile within the set of reference quantiles that contains previous probability scores that are closest in value to the 3% probability score of Carl. Once the matching quantile is determined, the next step is to determine whether the matching quantile falls with the target range of quantiles that defines positive use cases. For the sake of the example, let's assume that the matching quantile of a probability score of 3% is the 43^{rd} quantile. Since the 43^{rd} quantile is not within the range of target quantiles (which is between the 70^{th} and 100^{th} quantiles), it is determined that Carl does not satisfy the requirements of the first slider. As a result, the method does not classify Carl as being a member of the target audience and no response action is triggered.

Subsequent to the first prediction, the predictive model makes a second prediction based on further behavior data collected in relation to Carl. The second prediction is that the probability of Carl achieving the desired outcome is 6% (i.e., the probability score is 6%). The present method then determines if this probability score satisfies the requirements of the first slider 420. In this case, let's assume that the matching quantile of a probability score of 6% is the 74^{th} quantile. Since the 74^{th} quantile is within the range of target quantiles (between the 70^{th} and 100^{th} quantiles), it is determined that Carl has satisfied the requirements of the first slider 420. This determination alone could be used to identify Carl as being a member of the target audience and, thus, trigger an associated response action. However, because the functionality of the third slider 425 has been activated by the end user, a subsequent prediction is required that shows Carl satisfies the range of target quantiles of the third slider. In this case, the subsequent prediction would have to be a probability score that indicates a matching quantile within the 1^{st} and 30^{th} quantiles. Thus, if a third prediction resulted in a probability score of 2% and this equated to a matching quantile that is the 28^{th} quantile, Carl would have satisfied all the conditions shown in the settings of FIG. 4 and thereby be identified as a member of the target audience. With this, the response action would be triggered in relation to Carl.

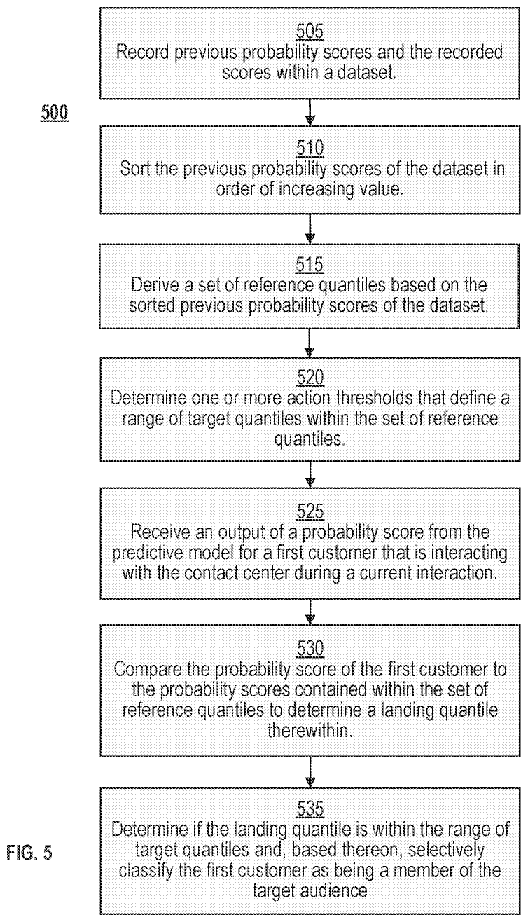

With reference now to FIG. 5, an exemplary method 500 is shown in accordance with the present invention. The method may be used in a contact center for classifying customers as being a member of target audience via operation of a predictive model. The predictive model may be configured to output a probability score for each of the customers that expresses a probability that the customer will achieve a predicted outcome. The predictive model may include a neural network. The method 500 may include the following steps.

The method 500 may begin, at step 505, by recording previous probability scores. The previous probability scores are defined as probability scores output by the predictive model in relation to previous interactions conducted by the contact center with respective previous customers. The recorded previous probability scores may then be grouped within a probability dataset (or, simply, dataset).

At step 510, the method 500 continues by sorting the previous probability scores of the dataset in order of an increasing value.

At step 515, the method 500 continues by deriving a set of reference quantiles based on the sorted previous probability scores contained in the dataset. The step of deriving the set of the reference quantiles may include dividing the sorted previous probability scores into a number of equal sized quantiles. As used herein, the equal sized quantiles of the set of reference quantiles is defined as each of the quantiles of the set of reference quantiles having an equal number of the probability scores.

At step 520, the method 500 continues by determining one or more action thresholds. The one or more action thresholds define a range of target quantiles within the set of reference quantiles. In exemplary embodiments, the step of determining the one or more action thresholds may include: providing a user interface on a device of an end user configured to allow the end user to provide input identifying a selected quantile within the set of reference quantiles; receiving an input from the end user via the device identifying the selected quantile; and deeming the selected quantile as defining an action threshold of the one or more action thresholds. As will be appreciated, the one or more action thresholds, as defined by user selected quantiles, define the boundaries by which the range of target quantiles are delineated.

At step 525, the method 500 continues by receiving an output of a probability score from the predictive model for a first customer that is interacting with the contact center during a current interaction.

At step 530, the method 500 continues by comparing the probability score of the first customer to the probability scores contained within the quantiles of the set of reference quantiles to determine a matching quantile therewithin for the probability score of the first customer. In exemplary embodiments, the matching quantile is the quantile within the set of reference quantiles determined to have probability scores that are closest in value to the probability score of the first customer.

At step 535, the method 500 continues by determining if the matching quantile is within the range of target quantiles and, based thereon, selectively classifying the first customer as being a member of the target audience. In exemplary embodiments, the first customer is selectively classified as a member of the target audience by: classifying the first customer as a member of the target audience if the matching quantile is found to be within the range of target quantiles; and classifying the first customer as not being a member of the target audience if the matching quantile is found to be outside of the range of target quantiles.

If the matching quantile of the first customer is found to be within the range of target quantiles so that the first customer is classified as being a member of the target audience, the method may further include the steps of triggering a response action be taken in relation to the first customer. In example embodiments, the response action is an automated action taken by automated systems of the contact center as a response to the first customer achieving the predicted outcome.

In exemplary embodiments, the step of recording the probability scores calculated previously by the predictive model for the previous customers may include recording the probability scores occurring within one or more previous operational units defined from a present operational unit of the contact center. For example, a sliding lookback window may be defined in relation to a current operational unit. The sliding lookback window may be defined as having a predetermined number of previous operational units occurring just prior to the current operational unit. Each of the probability scores calculated by the predictive model during the sliding lookback window may be recorded for inclusion in the dataset. Operational units for example may be a minute, hour, shift, day, week, etc. In other embodiments, the step of recording the previous probability scores may include recording, as the previous probability scores, a predetermined number of a most recent of the probability scores calculated by the predictive model.

The method of the present invention may further include the steps of: detecting the interaction involving the first customer, the interaction comprising the first customer interacting with a contact center resource over a communication channel; recording behavioral data of behavior exhibited by the first customer during the current interaction; and providing the behavioral data to the predictive model as inputs. In a preferred embodiment, the interaction may be a web session in which the first customer interacts with a website. In such a case, the response action may be offering the first customer a live chat or voice session with an agent.

The method may further include the step of determining the number of quantiles of the set of reference quantiles. In an exemplary embodiment, the step of determining the number of quantiles within the set of reference quantiles may include: providing a user interface on a device of an end user configured to allow the end user to provide input selecting between a plurality of alternatives that each specify a different number of quantiles for the set of reference quantiles; and receiving an input from the end user via the device indicating a selection of one of the plurality of alternatives. For example, the plurality of alternatives may include 10 quantiles, 100 quantiles, and/or 1,000 quantiles.

As one of skill in the art will appreciate, the many varying features and configurations described above in relation to the several exemplary embodiments may be further selectively applied to form the other possible embodiments of the present invention. For the sake of brevity and taking into account the abilities of one of ordinary skill in the art, each of the possible iterations is not provided or discussed in detail, though all combinations and possible embodiments embraced by the several claims below or otherwise are intended to be part of the instant application. In addition, from the above description of several exemplary embodiments of the invention, those skilled in the art will perceive improvements, changes and modifications. Such improvements, changes and modifications within the skill of the art are also intended to be covered by the appended claims. Further, it should be apparent that the foregoing relates only to the described embodiments of the present application and that numerous changes and modifications may be made herein without departing from the spirit and scope of the present application as defined by the following claims and the equivalents thereof.

That which is claimed:

1. A computer-implemented method for use in a contact center for classifying customers as being a member of target audience via operation of a predictive model, the predictive model being configured to output a probability score for each of the customers that expresses a probability that the customer will achieve a predicted outcome, the method comprising the steps of:
recording previous probability scores, wherein each of the previous probability scores comprise a probability score output by the predictive model in relation to a previous interaction conducted by the contact center with respective to a previous customer, and grouping the recorded previous probability scores within a dataset;
sorting the previous probability scores of the dataset in order of an increasing value;
deriving a set of reference quantiles based on the sorted previous probability scores contained in the dataset, wherein the deriving the set of the reference quantiles comprises dividing the sorted previous probability scores into a number of equal sized quantiles;
determining one or more action thresholds, the one or more action thresholds defining a range of target quantiles within the set of reference quantiles;
receiving an output of a probability score from the predictive model for a first customer that is interacting with the contact center during a current interaction;
comparing the probability score of the first customer to the previous probability scores contained within the quantiles of the set of reference quantiles to determine a matching quantile therewithin for the probability score of the first customer; and
determining if the matching quantile is within the range of target quantiles and, based thereon, selectively classifying the first customer as being a member of the target audience.

2. The method of claim 1, wherein the first customer is selectively classified as a member of the target audience by:
classifying the first customer as a member of the target audience if the matching quantile is found to be within the range of target quantiles; and
classifying the first customer as not being a member of the target audience if the matching quantile is found to be outside of the range of target quantiles.

3. The method of claim 2, further comprising the step of:
in response to the first customer being classified as a member of the target audience, triggering a response action be taken in relation to the first customer.

4. The method of claim 3, wherein the response action comprises an automated action taken by automated systems of the contact center as a response to the first customer being classified as a member of the target audience.

5. The method of claim 4, further comprising the steps of:
detecting the interaction involving the first customer, the interaction comprising the first customer interacting with a contact center resource over a communication channel;
recording behavioral data of behavior exhibited by the first customer during the current interaction; and
providing the behavioral data to the predictive model as inputs.

6. The method of claim 5, wherein the interaction comprises a web session in which the first customer interacts with a website; and
wherein the response action comprises offering, via the web session, the first customer a live chat or voice session with an agent.

7. The method of claim 2, wherein:
the equal sized quantiles of the set of reference quantiles comprises each of the quantiles of the set of reference quantiles having an equal number of the previous probability scores;
the matching quantile comprises the quantile within the set of reference quantiles determined to have the previous probability scores that are closest in value to the probability score of the first customer; and
the predictive model comprises a neural network.

8. The method of claim 2, wherein the step of recording the previous probability scores calculated previously by the predictive model for the previous customers comprises:
recording the previous probability scores that occurred within one or more previous operational units defined in relation to a present operational unit of the contact center.

9. The method of claim 2, wherein the step of recording the previous probability scores comprises:
determining a sliding lookback window in relation to a current operational unit, wherein the sliding lookback window comprising a predetermined number of previous operational units occurring just prior to the current operational unit; and
recording, as the previous probability scores, each of the probability scores calculated by the predictive model during the sliding lookback window;
wherein the operational unit comprises one of: a minute; an hour; a shift; a day; and a week.

10. The method of claim 2, wherein the step of recording the previous probability scores comprises:
recording, as the previous probability scores, a predetermined number of a most recent of the previous probability scores calculated by the predictive model.

11. The method of claim 2, further comprising the step of determining the number of quantiles of the set of reference quantiles.

12. The method of claims 11, wherein the step of determining the number of quantiles within the set of reference quantiles comprises:
providing a user interface on a device of an end user configured to allow the end user to provide input selecting between a plurality of alternatives that each specify a different number of quantiles for the set of reference quantiles; and
receiving an input from the end user via the device indicating a selection of one of the plurality of alternatives;
wherein the plurality of first alternatives comprise at least one of the following: 10 quantiles; 100 quantiles; and 1,000 quantiles.

13. The method of claim 2, wherein the step of determining the one or more action thresholds comprises:
providing a user interface on a device of an end user configured to allow the end user to provide input identifying a selected quantile within the set of reference quantiles;
receiving an input from the end user via the device identifying the selected quantile; and
deeming the selected quantile as comprising an action threshold of the one or more action thresholds.

14. A system for classifying customers of a contact center as being a member of target audience via operation of a predictive model, the predictive model being configured to output a probability score for each of the customers that expresses a probability that the customer will achieve a predicted outcome, the system comprising:
a processor; and
a memory storing instructions which, when executed by the processor, cause the processor to perform the steps of:
recording previous probability scores, wherein the previous probability scores comprise probability scores output by the predictive model in relation to previous interactions conducted by the contact center with respective previous customers, and grouping the recorded previous probability scores within a dataset;
sorting the previous probability scores of the dataset in order of an increasing value;
deriving a set of reference quantiles based on the sorted previous probability scores contained in the dataset, wherein the deriving the set of the reference quantiles comprises dividing the sorted previous probability scores into a number of equal sized quantiles;
determining one or more action thresholds, the one or more action thresholds defining a range of target quantiles within the set of reference quantiles;
receiving an output of a probability score from the predictive model for a first customer that is interacting with the contact center during a current interaction;
comparing the probability score of the first customer to the previous probability scores contained within the quantiles of the set of reference quantiles to determine a matching quantile therewithin for the probability score of the first customer; and
determining if the matching quantile is within the range of target quantiles and, based thereon, selectively classifying the first customer as being a member of the target audience.

15. The system of claim 14, wherein the first customer is selectively classified as a member of the target audience by:
classifying the first customer as a member of the target audience if the matching quantile is found to be within the range of target quantiles; and
classifying the first customer as not being a member of the target audience if the matching quantile is found to be outside of the range of target quantiles.

16. The system of claim 15, wherein the instructions stored by the memory further cause the processor to perform the steps of:
in response to the first customer being classified as a member of the target audience, triggering a response action be taken in relation to the first customer.

17. The system of claim 16, wherein the instructions stored by the memory further cause the processor to perform the steps of:
detecting the interaction involving the first customer, the interaction comprising the first customer interacting with a contact center resource over a communication channel;
recording behavioral data of behavior exhibited by the first customer during the current interaction; and
providing the behavioral data to the predictive model as inputs.

18. The system of claim 17, wherein the interaction comprises a web session in which the first customer interacts with a website; and
wherein the response action comprises offering, via the web session, the first customer a live chat or voice session with an agent.

19. The system of claim 18, wherein the step of recording the previous probability scores comprises:
recording, as the previous probability scores, a predetermined number of a most recent of the previous probability scores calculated by the predictive model.

20. The system of claim 15, wherein the step of determining the one or more action thresholds comprises:
providing a user interface on a device of an end user configured to allow the end user to provide input identifying a selected quantile within the set of reference quantiles;
receiving an input from the end user via the device identifying the selected quantile; and
deeming the selected quantile as defining an action threshold of the one or more action thresholds.
